(19) United States
(12) Patent Application Publication
(10) Pub. No.: US 2005/0161622 A1
(43) Pub. Date: Jul. 28, 2005

(54) Broken tool detector

(76) Inventors: Colin Timothy Bell, Berkeley (GB); Victor Gordon Stimpson, Avening (GB)

Correspondence Address: OLIFF & BERRIDGE, PLC, P.O. BOX 19928, ALEXANDRIA, VA, 22320, US

(21) Appl. No.: 10/512,944

(22) PCT Filed: May 2, 2003
(86) PCT No.: PCT/GB03/01930

(51) Int. Cl. G21G 4/00

(52) U.S. Cl. 250/493.1

(57) ABSTRACT

This invention relates to the detection of tool (50) and other items used on machines by use of a detector (5). An emitter (10) emits a beam of laser light (20) and sensor (30) is used to determine the presence or absence of a tool (50) when the tool is positioned in the beam. If any light is present at the sensor (30) within a predetermined time period then the tool must be broken and the output of the detector is latched. Thus if a broken tool is present and contamination obstructs the beam then this is ignored provided some light is sensed.

This invention relates to the detection of tools and the like in a beam of radiation. In particular, but not exclusively, the invention relates to the detection of a cutting tool in the path of light emitted by a broken cutting tool detector.

The detection of cutting tools and the absence of such a tool (i.e. a broken or missing tool) can be detected by a known tool detector. Such a device is shown in our prior patent application EP 1050368. Generally a workpiece machining cycle includes one or more tool detection routines so that scrap work is avoided. The routine may consist of:
activating the broken tool detector;
awaiting a “tool found” signal from the detector;
carrying on with the machining cycle or stopping the cycle if no signal is present.

This routine has a flaw when “break beam” type tool detectors are used in a machine tool environment. Swarf and coolant can break the beam during the routine and provide a false “tool found” signal. Thus the detector will report that all is well when in fact the tool is not present. One or more repeats of the routine can be made as a confirmation but this adds time to the cycle and so is undesirable.

According to one aspect of this invention there is provided a method of operating a break beam tool detector having a radiation emitter for producing a beam of radiation, a radiation sensor for sensing the radiation and an output, the method comprising the steps of:
activating emitter to emit the radiation;
monitoring radiation at the sensor for a predetermined time period; and
changing the output of the detector only if the emitted radiation is sensed by the sensor within the predetermined time period.

Thus embodiments of the invention provide for any “no tool found” (i.e. light at the sensor) signal to cause a latching of the output of the detector which can be detected as an “M” code in a machining cycle. Such a detection routine is immune to swarf and coolant blocking the beam because momentary “tool found” (i.e. beam broken) signals are ignored, rather, any “no tool found” signals cause the latching of the output. If no light was detected during the predetermined time then a “good tool” signal will be issued by the tool detector.

According to a second aspect the invention provides a break beam tool detector comprising a radiation emitter for producing a beam of radiation, a radiation sensor for sensing the radiation and an output, wherein the detector is operable such that following activation of the emitter the output of the detector is changed only if the emitted radiation is sensed by the sensor within a predetermined time period.

According to another aspect the invention extends to a method of performing a routine on a machine tool, the machine tool being adapted for holding an item and including an item detector having a radiation emitter for generating a beam of radiation, a radiation sensor for sensing the radiation, and an output, comprising the steps in any suitable order, of:
moving the item into the path taken by the beam of the radiation;
activating the radiation emitter of the item detector to generate the beam of radiation;
sensing the presence or absence of the radiation at the sensor;
changing the output of the detector if radiation is sensed at the sensor within a predetermined time period; and
responding to the output after the predetermined time period.

According to yet another aspect the invention extends to a machine tool comprising:
an item holder, an item detector, having a radiation emitter of generating a beam of radiation, a radiation sensor for sensing the radiation and an output;
wherein the machine is operable such that the tool is moved into the path taken by the beam of the radiation;
wherein the detector is operable to activate the radiation emitter to generate the beam of radiation, wherein the detector is operable to sensing the presence or absence of the radiation at the sensor,
wherein the output of the detector is changed only if radiation if sensed at the sensor within a predetermined time period.

Embodiments of the invention will now be described in more detail with reference to the drawings, wherein:

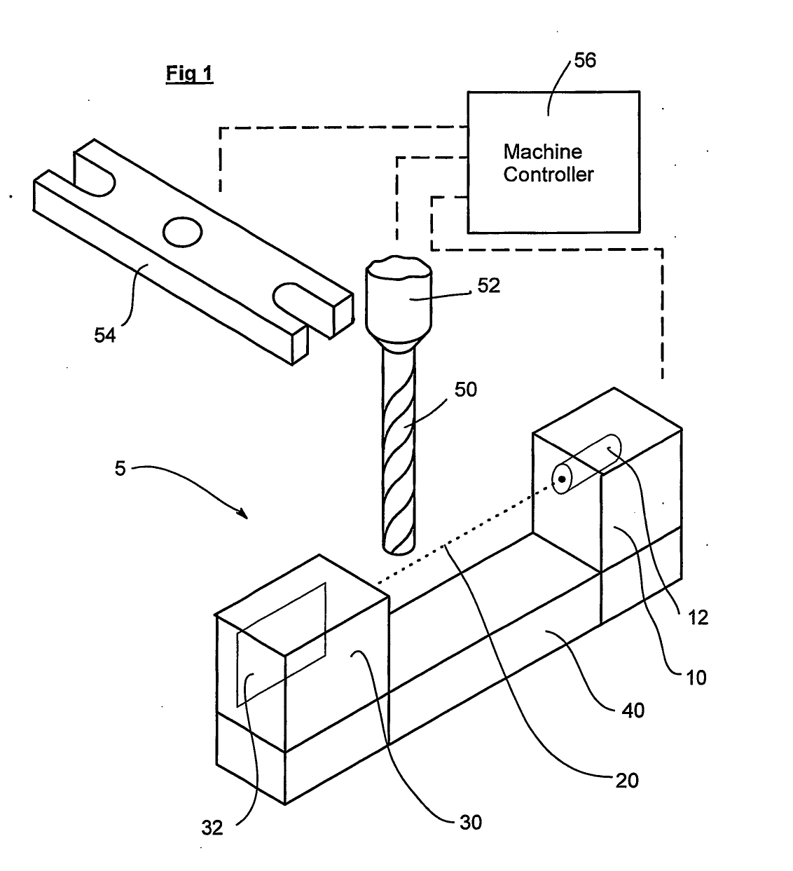

FIG. 1 shows a break beam type broken tool detection device;

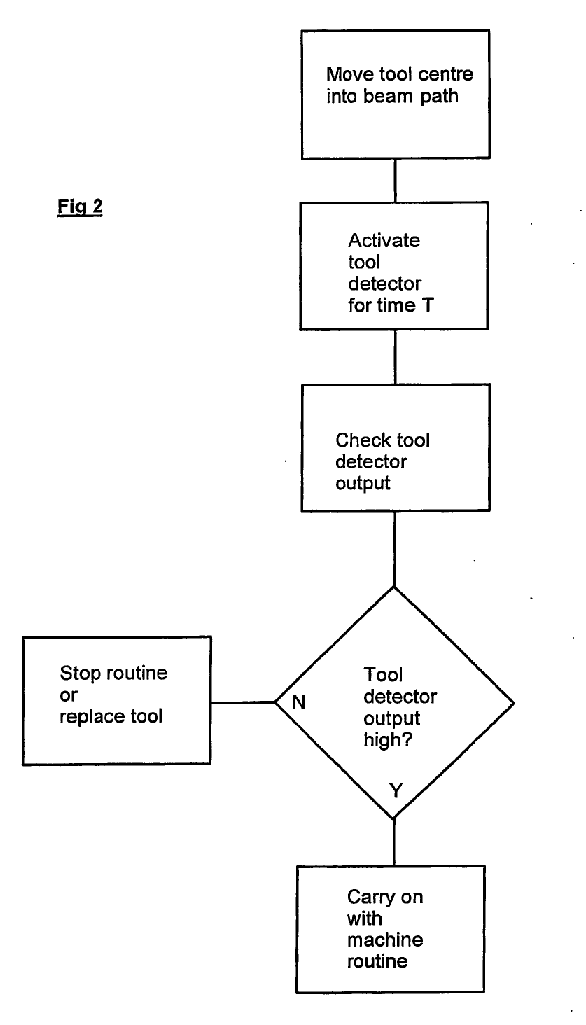

FIG. 2 shows a flow diagram illustrating a method of tool breakage detection; and

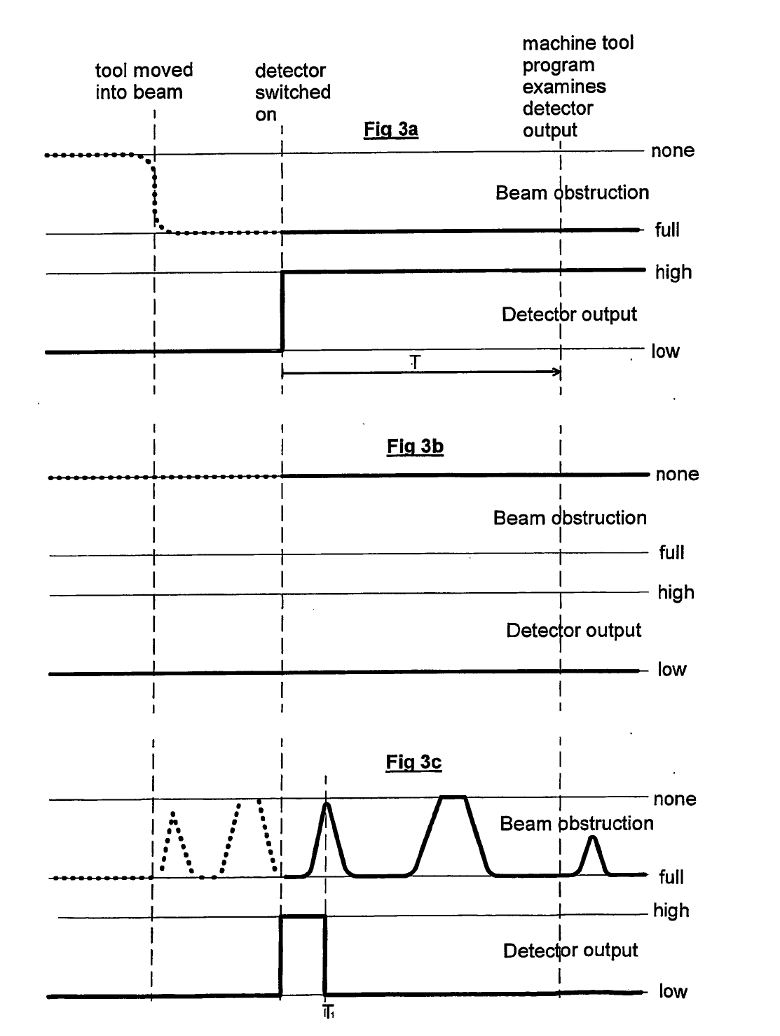

FIGS. 3a,b and c show a graphical relationship between detector output and beam obstruction.

FIG. 1 shows a break beam type detector 5, one such example being described in our prior art patent application EP 1050368. The detector 5 has a radiation emitter 10, in this instance a laser light source 12, emitting a beam 20 of light and a light sensor 30 for sensing the presence or absence of all or part of the beam. The emitter and sensor are mounted to a support structure 40. An automatic tool change device 54 may mechanically exchange tools into and out of a toolholder 52. When a tool 50 held in the toolholder 52 is passed through the beam 20 then circuitry 32 within the sensor 30 will cause the output of the detector to change.

FIG. 2 shows the steps performed by the machine tool controlled by the machine controller (56 FIG. 1). The controller 56 has a machining routine in which it is desired to detect the state of the tool. Such a routine will usually be performed when a tool is first loaded automatically into the tool holder 52. In that way machining cycles which are carried out whilst a tool is broken can be avoided. Alternatively or as well as the above, the routine can be performed at the end of a machining cycle with a particular tool. In either case an indication will be provided that something has gone wrong with the last machined workpiece and the tool, so operator intervention can be made.

The routine is as detailed in the flow diagram of FIG. 2 and is described in more detail below.

The tool is moved so that its approximate centre is in line with the beam 20. In this example the beam is narrower than the tool so when in place will completely obscure the beam, provided that it is intact and not broken. It is desirable that the end of the tool is brought into the beam rather than its base, because detection of a tool with only a broken end portion could be made in this way if its base is intact.

The tool detector is activated when the tool should have obscured the beam. Activation is made by the machine tool controller routine for a given predetermined time. At activation the circuitry 32 of the detector 5 monitors the light level of the sensor 30 for the predetermined time. After such a time the output will either be latched to a high state or a low state, e.g. +24 volts d.c. or 0 volts d.c. The output is fed into an input port of the controller for informing the routine running within the controller at the end of the time period. The time period is determined by the machine tool controller and can be set to any length, dependant principally on the amount of coolant that is expected to be present during the cycle, e.g. 10 mS to 10 seconds.

If the output is high then the tool is considered to be good, and the routine is continued, e.g. cutting is continued. If the output is low then the routine can be stopped and the fault flagged. Alternatively a spare tool can be substituted if the output is low.

FIG. 3 shows the relationship between the blocked or unblocked beam path 20 and the output of the detector 5. In each of the graphs of FIGS. 3a,b and c the top band represents the degree of blocking of the beam, and the lower band in each Figure represents the output of the sensor circuit 32.

In FIG. 3a there is shown an output when a good tool is detected. The first part of the upper line is shown as a dotted line to denote that it is a notional part of the line, i.e. detection is not taking place e.g. because the beam has not yet been switched on so there is no beam to be obscured and the dotted line shows what would happen if the beam were present.

When the tool is centred in the beam path the detector is activated and the presence or absence of light from the beam is detected for a time T by sensor circuit 32. In FIG. 3a no light is detected so the output goes high immediately and stays high until the machine tool controller routine reads the output (voltage in this case). The routine reports a good tool and is continued.

FIG. 3b shows the same relationship illustrated in FIG. 3a but a broken tool is present in this case. Since no beam obstruction takes place the output starts low and remains low because at least some of the beam light has been detected by the sensor circuit during time T. When the machine tool routine reads the output a fault is apparent and appropriate action is taken, e.g. stopping of the machine or changing the tool.

FIG. 3c shows a more realistic situation in a machine tool environment. Here a broken tool is present as well as contamination in the form of swarf and coolant etc. Thus the beam obstruction flickers between no obstruction and full or partial obstruction caused by the contamination. When the detector circuit 32 detects light for the first time (at point T₁) within the time T then the output is latched to a low state. Again in such a circumstance a fault is apparent when the machine tool reads the output.

So, using the system described above there is no need to have clean conditions for monitoring tool breakage.

Many modifications and variants to the foregoing will be apparent to the skilled addressee. The invention has been described for use with a machine tool but other similar machines could be used e.g. robotic devices which need to ensure an item has been picked up. The invention has been described for use in detecting the presence or absence of tools but other items could be detected e.g. part marking devices or welding rods. When used to detect a tool or similar, the tool etc need not be located in a tool holder 52, e.g. the tool might be located in a tool carousel or other off-machine tool holding device whilst it is detected.

More particularly the machine tool controller method employed provides that the detector 5 is activated after the tool is centred in the beam path 20. However it is possible that the detector is powered and the beam is in use before the tool is centred. In such an instance the sensor circuit 32 will not be caused to latch until light is sensed within the time period T, the period being started by the machine tool controller. Whilst the detection beam 20 utilises laser light, other forms of electromagnetic radiation are envisaged also, e.g. infra-red or r.f radiation. The beam might be wider than the tool, provided a significant portion (e.g. more than half) of the radiation of the beam is obscured by the item to be detected.

The predetermined time period T may be provided by a pulse of light from the laser, an activation of the sensor for a period T, via the machine controller, as a result of a beam shuttering system, or as preferred by a timer internal to the detector at circuit 32.

The embodiments illustrated show a radiation emitter and a radiation sensor aligned so that a beam of radiation between the emitter and the sensor is broken during detection of an item in the beam. However the invention may b e utilised with a detector wherein the emitter and sensor are adjacent and detection takes place by reflection of a beam off an item and onto the sensor.

The invention has been described as having an output of either 0 or 24 d.c. volts. It is possible that other voltage outputs may be used to suit the input of the machine tool's controller. Thus the voltage could be between 0 and 50 volts. Additionally some controllers require an electrical circuit to be opened and closed rather than a voltage signal, so the output could be fed to a relay or the like so that the relay latches normally on or normally off. In this way the output has a resistance which changes.

1-24. (canceled)

25. A method of operating a break beam tool detector having a radiation emitter for producing a beam of radiation, a radiation sensor for sensing the radiation and an output, the method comprising the steps of:
positioning a tool in the beam;
activating emitter to emit the beam radiation;
monitoring radiation at the sensor for a predetermined time period; and
changing the output of the detector only if the emitted radiation sensed by the sensor within the predetermined time period exceeds a predetermined amount.

26. A method of operating a break beam tool detector as claimed in claim 25 wherein the changing of the output comprises latching of the output.

27. A method of operating a break beam tool detector as claimed in claim 25 wherein the radiation is a beam of light from a laser.

28. A method of operating a break beam tool detector as claimed in claim 25 wherein the output is a constant voltage of between 0 and 50 volts d.c.

29. A method of operating a break beam tool detector as claimed in claim 25 wherein the output has a resistance and the changed output is a change in that resistance.

30. A method of operating a break beam tool detector as claimed in claim 29 wherein the output further comprises a relay for providing the resistance and the changed output is a change in the state of the relay.

31. A method of operating a break beam tool detector as claimed in claim 25 wherein the predetermined period of time is adjustable.

32. A break beam tool detector comprising a radiation emitter for producing a beam of radiation, a radiation sensor for sensing the radiation and an output, wherein the detector is operable such that following activation of the emitter the output of the detector is changed only if the emitted radiation sensed by the sensor within a predetermined time period exceeds a predetermined amount when a tool is in the beam.

33. A break beam tool detector as claimed in claim 32 wherein the change in output comprises a latching of the output.

34. A break beam tool detector as claimed in claim 32 wherein the radiation is a beam of light from a laser.

35. A break beam tool detector as claimed in claim 32 wherein the output is a constant voltage of between 0 and 50 volts d.c.

36. A break beam tool detector as claimed in claim 32 wherein the output has a resistance and the changed output is a change in that resistance.

37. A break beam tool detector as claimed in claim 36 wherein the output further comprises a relay for providing the resistance and the changed output is a change in the state of the relay.

38. A break beam tool detector as claimed in claim 32 wherein the predetermined period of time is adjustable.

39. A method of performing a routine on a machine tool, the machine tool being adapted for holding an item and including an item detector having a radiation emitter for generating a beam of radiation, a radiation sensor for sensing the radiation, and an output, comprising the steps in any suitable order, of:
moving the item into the path taken by the beam of the radiation;
activating the radiation emitter of the item detector to generate the beam of radiation;
sensing the presence or absence of the radiation at the sensor;
changing the output of the detector if radiation is sensed at the sensor within a predetermined time period; and
responding to the output after the predetermined time period.

40. A method of performing a routine on a machine tool, as claimed in claim 39 wherein the change in output comprises latching of the output.

41. A method of performing a routine on a machine tool as claimed in claim 39 wherein the step of responding to the output after the predetermined time period includes either continuing operation of the machine, stopping the operation of the machine or exchanging the item of the machine.

42. A method of performing a routine on a machine tool, as claimed in claim 39 wherein the radiation is a beam of light from a laser.

43. A method of performing a routine on a machine tool, as claimed in claim 39 wherein the output is a constant voltage of between 0 and 50 volts d.c.

44. A method of performing a routine on a machine tool, as claimed claim 39 wherein the output has a resistance and the changed output is a change in that resistance.

45. A method of performing a routine on a machine tool, as claimed in claim 44 wherein the output further comprises a relay for providing the resistance and the changed output is a change in the state of the relay.

46. A method of performing a routine on a machine tool as claimed in claim 39 wherein the predetermined period of time is adjustable.

47. A machine tool comprising:
an item holder, an item detector, having a radiation emitter of generating a beam of radiation, a radiation sensor for sensing the radiation and an output;
wherein the machine is operable such that the item holder is moved such that the items should be in the path taken by the beam of the radiation;
wherein the detector is operable to activate the radiation emitter to generate the beam of radiation, wherein the detector is operable to sense the presence or absence of the radiation at the sensor, and
wherein the output of the detector is changed only if radiation if sensed at the sensor within a predetermined time period.

48. A machine tool as claimed in claim 47 wherein the changing of the output comprises latching of the output.
